(19) United States
(12) Patent Application Publication
(10) Pub. No.: US 2026/0145556 A1
(43) Pub. Date: May 28, 2026

(54) CHARGING CONTACT DEVICE AND METHOD FOR OPERATING THE CHARGING CONTACT DEVICE

(71) Applicant: TE Connectivity Solutions GmbH, Schaffhausen (CH)

(72) Inventors: Dominik HEISS, Schaffhausen (CH); Frank WITTROCK, Schaffhausen (CH); Mike ISKRA, Schaffhausen (CH); Philipp KOWARSCH, Schaffhausen (CH)

(21) Appl. No.: 19/400,081

(22) Filed: Nov. 25, 2025

(30) Foreign Application Priority Data
Nov. 28, 2024 (DE) 102024135311.2

(51) Int. Cl. B60L 53/16

(52) U.S. Cl. CPC B60L 53/16; H02J 7/70

(57) ABSTRACT

A charging contact device includes a contact housing, a locking unit and a charging contact arrangement, wherein the first charging contact element comprises a first sub-section extending along a plug-in axis for making electrical contact with a mating contact element of a charging plug and a second sub-section offset from the first sub-section, wherein the contact housing comprises, on a first end face, a receiving contour with at least one receiving space and a mating contact receptacle, wherein the contact housing delimits a locking space and a housing interior away from the first end face, wherein the second sub-section of the first charging contact element is arranged in the housing interior, and the first charging contact element passes through the contact housing and protrudes into the housing interior with the second sub-section, wherein the contact housing comprises a pin opening which extends between the receiving space and the locking space, wherein the locking unit is arranged in the locking space of the contact housing and a locking pin of the locking device engages in the pin opening.

### CROSS REFERENCE TO RELATED APPLICATIONS

This application claims the benefit of DE Application No. 102024135311.2, filed 28 Nov. 2024, the subject matter of which is herein incorporated by reference in its entirety.

### BACKGROUND OF THE INVENTION

The subject matter herein relates to a charging contact device and to a method for operating the charging contact device.

US 2017/0338594 A1 discloses a charging socket.

There is a need for an improved charging contact device and an improved method for operating the charging contact device.

### BRIEF DESCRIPTION OF THE INVENTION

In one embodiment, a charging contact device for a vehicle, in particular an electrically powered vehicle or a hybrid vehicle, is provided including a contact housing, a locking unit and a charging contact arrangement. The charging contact arrangement comprises at least one first charging contact element that is designed to transmit an electrical charging current. The first charging contact element comprises a first subsection extending along a plugin axis for electrically contacting a mating contact element of a charging plug and a second subsection offset from the first subsection. The contact housing, which is preferably formed in one piece and from a uniform material, comprises a receiving contour on a first end face with at least one receiving space and a mating contact receptacle arranged offset from the receiving space. The contact housing also delimits a locking space and a housing interior away from the first end face in relation to the plugin axis. The second subsection of the first charging contact element is arranged in the housing interior. Furthermore, the first charging contact element extends through the contact housing and protrudes with the second subsection into the housing interior. The contact housing also comprises a pin opening that extends between the receiving space and the locking space. The locking unit is arranged in the locking space of the contact housing.

This design has the advantage that, by integrating the housing interior and the locking space, the locking unit is accommodated in the contact housing, thereby making the charging contact device particularly compact. Furthermore, this allows the installation space requirements for the charging contact device to be kept particularly low and, in particular, allows the charging contact device to be installed on the vehicle side even in very limited installation spaces.

Furthermore, the contact housing can be sealed particularly easily with respect to the surroundings of the contact housing, so that corrosion, particularly in the housing interior, can be avoided on the first charging contact element.

In a further embodiment, the locking unit comprises a locking drive and a locking pin that is mechanically driven by the locking drive. The locking drive is designed to move the locking pin between an unlocking position and a locking position offset from the unlocking position. In the unlocking position, a first pin end of the locking pin engages in the pin opening, and in the locking position, the locking pin passes through the pin opening and protrudes with the first pin end into the receiving space. A second pin end arranged opposite the first pin end is arranged in the locking space of the contact housing in both the unlocking position and the locking position. The locking pin can be used to lock a charging plug on the charging contact device from the locking space and secure it before removal.

In a further embodiment, the contact housing comprises a drive carrier arranged in the locking space and/or the housing interior. The locking unit is attached to the drive carrier, wherein the drive carrier is formed in one piece with and from the same material as the contact housing. This design has the advantage that the contact housing can be manufactured inexpensively together with the drive carrier, for example in an injection moulding process.

In a further embodiment, the contact housing comprises a first housing wall, a second housing wall and a housing web, wherein the first housing wall extends circumferentially around the plugin axis and delimits the locking space and the housing interior in the radial direction relative to the plugin axis. The second housing wall connects at the end face to the first housing wall and axially delimits the housing interior and the locking space. Furthermore, the second housing wall separates the locking space from the receiving space. The housing web is arranged on the first housing wall and the second housing wall and separates the locking space from the housing interior at least in sections. In particular, the drive carrier can be arranged on the housing web, for example, so that the locking unit is mechanically secured in the contact housing with particular stability. Furthermore, the housing web stiffens the contact housing on the inside so that forces can be well supported by the charging contact device when the charging plug is inserted into or removed from the charging contact device.

In a further embodiment, the charging contact device comprises a first sealing element, wherein the contact housing comprises a seal carrier at the pin opening, which seal carrier is arranged in the locking space. The seal carrier surrounds the first sealing element at the circumference and secures the first sealing element to the pin opening. The locking pin passes through the first sealing element and the first sealing element separates the locking space from the receiving space in a fluid-tight manner. This design has the advantage that the charging contact device in particular is fluid-tight, in particular liquidtight and dirttight, and that even in adverse weather conditions, a secure seal of the locking space and the housing interior with respect to the surroundings is ensured, and thus even when the charging contact device is exposed to the weather, no liquid or dirt enters the locking space or the housing interior, even if the charging contact device is not covered.

In a further embodiment, the charging contact device comprises a locking cover, wherein the contact housing comprises a second housing opening. The second housing opening opens into the locking space. The locking cover is arranged at the second housing opening and closes the locking space. This design has the advantage that the locking space of the contact housing can be easily closed by means of the locking cover.

In a further embodiment, the second housing opening is arranged opposite the pin opening. This design has the advantage that a guide for the locking pin can be integrated particularly easily, for example on the locking cover.

In a further embodiment, the locking cover comprises a cover section and a pin guide, wherein the pin guide is arranged on the inside of the cover section and extends from the cover section in the direction of the pin opening. The locking pin engages in the pin guide on a side facing away from the pin opening, and the pin guide guides the locking pin in a movement between the unlocking position and the locking position. The cover section is arranged at the second housing opening and closes the second housing opening at the locking space. This design has the advantage that the guide and the cover section can be manufactured in an integrated manner, for example in an injection moulding process. Furthermore, the locking cover can be placed on top and, when closed, the locking pin engages with the pin guide, simplifying the assembly of the charging contact device.

In a further embodiment, the locking drive comprises a locking motor and a locking gearing, wherein the locking motor is connected on the output side to a gearing input side of the locking gearing. The locking gearing comprises at least one rack gear with a rack, wherein the rack is connected to the locking pin in order to move the locking pin in a straight line along a locking axis between the locking position and the unlocking position. This design has the advantage that the movement of the locking pin in a straight line ensures that the first sealing element reliably seals the locking pin.

In a further embodiment, the charging contact device comprises a housing cover, wherein the housing cover is attached to the contact housing on a side of the contact housing opposite the receiving space and closes off the housing interior and the locking space. This design has the advantage that the charging contact device comprises particularly few elements to close both the locking space and the housing interior. In particular, the charging contact device can be constructed with only three components: the contact housing, the locking cover and the housing cover. The small number of components makes the charging contact device particularly easy to assemble.

In a further embodiment, the charging contact device comprises a control contact device, wherein the control contact device is arranged on a side facing away from the receiving space. The control contact device comprises at least one first control contact and a second control contact arranged offset from the first control contact. The locking unit can be controlled via the first control contact. For example, a data signal and/or electrical power for operating the locking unit can be transmitted via the first control contact. The second control contact can be used to provide information about an operating state of the charging contact arrangement, in particular a temperature and/or a charging state and/or a data signal transmitted via the second charging contact element and/or a position of the locking pin. The control contact device is arranged on the housing cover on a side facing away from the charging contact device. This design has the advantage that a cable harness to be connected to the charging contact device is particularly simple in design.

In a further embodiment, the locking drive comprises a locking motor and a locking gearing, wherein the locking gearing comprises a gearing input side and a gearing output side, wherein the gearing input side of the locking gearing is connected to the locking motor in a torque-locking manner, wherein the gearing output side of the locking gearing is connected to the locking pin, wherein the locking gearing is preferably designed as a reduction gearing, wherein the locking gearing is self-locking so that the locking gearing can only be driven via the gearing input side and not via the gearing output side. This prevents unwanted movement of the locking pin, e.g. while driving.

The charging contact device, which is designed as described above, can be operated particularly easily in that, in the unlocking position, a first pin end of the locking pin engages in the pin opening and, in the locking position, the pin opening is penetrated and the first pin end protrudes into the receiving space. The locking unit moves the locking pin between the unlocking position and the locking position.

It is particularly advantageous if the locking pin is moved in a straight line between the locking position and the unlocking position.

### BRIEF DESCRIPTION OF THE DRAWINGS

The invention will be explained in more detail below with reference to the figures, in which:

FIG. 1 shows a schematic representation of a charging system;

FIG. 2 shows a sectional view along a plane of section A-A shown in FIG. 1 through the charging system shown in FIG. 1;

FIG. 3 shows a perspective view of the charging contact device with the view directed towards the first end face;

FIG. 4 shows an enlarged sectional view of the charging contact device shown in FIGS. 1 and 2 along the sectional plane A-A shown in FIG. 1;

FIG. 5 shows a perspective view of the charging contact device;

FIG. 6 shows a perspective view of the charging contact device;

FIG. 7 shows a perspective view of the locking cover;

FIG. 8 shows another perspective view of the locking cover shown in FIG. 7;

FIG. 9 shows a perspective view of the charging contact device shown in FIGS. 1 to 8 with the locking cover and the locking unit;

FIG. 10 shows a detail of a perspective view of the charging contact device shown in FIGS. 1 to 9, viewed from the interior of a vehicle towards the charging contact device;

FIG. 11 shows a sectional view along the plane of section A-A shown in FIG. 1 through the charging system in the locking position; and

FIG. 12 shows a sectional view along the plane of section A-A shown in FIG. 1 through the charging system, wherein the charging system is unlocked.

### DETAILED DESCRIPTION OF THE INVENTION

Reference is made to a coordinate system in the following figures. The coordinate system comprises an x-axis, a y-axis and a z-axis. The coordinate system can be designed as a right-angled system.

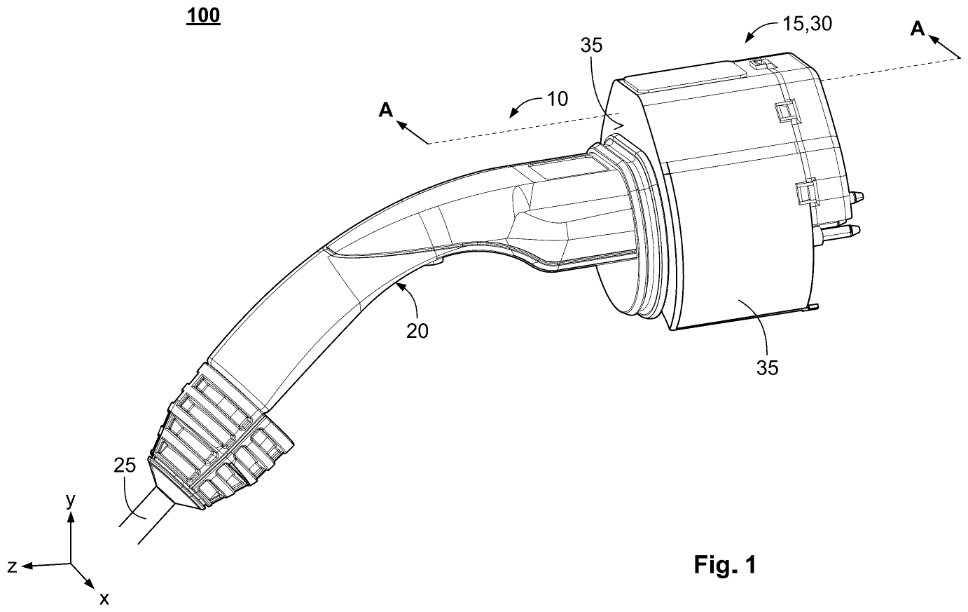

FIG. 1 shows a schematic view of a charging system 10.

The charging system 10 comprises a charging contact device 15 and a charging plug 20. The charging plug 20 is electrically connected to a charging cable 25. The charging plug 20 can also be connected via the charging cable 25, for example by means of a charging station (not shown) which is, for example, connected to the mains.

The charging contact device 15 is arranged in a vehicle 30 and can be electrically connected to an electrical energy storage device (not shown in FIG. 1).

The charging contact device 15 comprises a first end face 35 that faces the surroundings 100 of the vehicle 30 and is thus exposed to environmental influences, even if a charging flap of the vehicle 30 (not shown) protects the charging contact device 15 when closed, for example while the vehicle 30 is in motion.

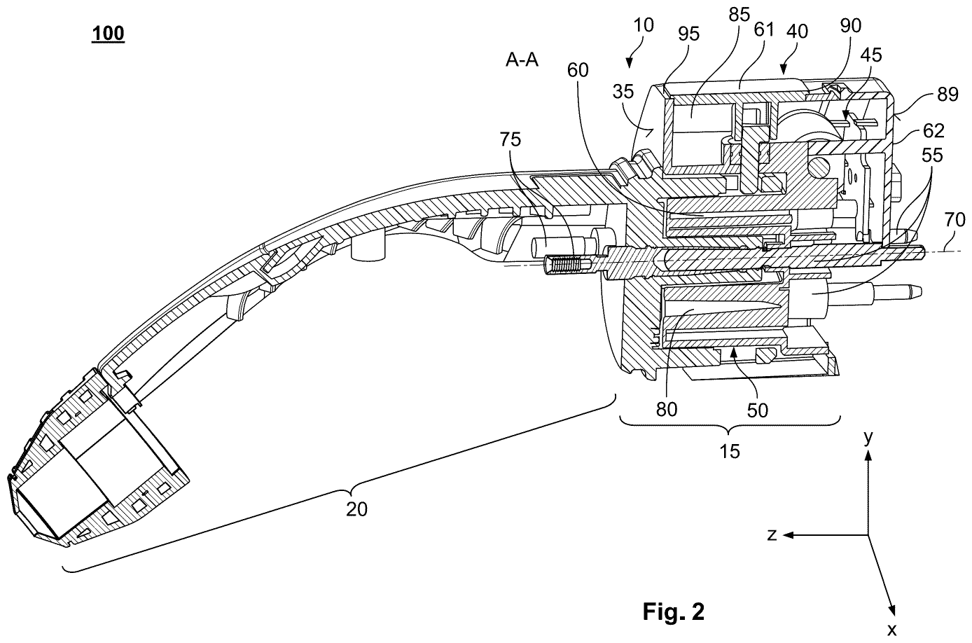

FIG. 2 shows a sectional view along a plane of section A-A, shown in FIG. 1, through the charging system 10 shown in FIG. 1.

The charging contact device 15 comprises a contact housing 40, a locking unit 45, a charging contact arrangement 50, a locking cover 61 and a housing cover 62. The charging contact arrangement 50 is arranged in accordance with, for example, an IEC Type 2 arrangement (IEC 62196 Type 2, EN 62196 Type 2).

For example, the charging contact arrangement 50 comprises at least one first charging contact element 55, preferably several first charging contact elements 55, and a second charging contact element 60 arranged relative to the first charging contact element 55, for example two second charging contact elements 60.

The first charging contact element 55 may, for example, be designed to transmit electrical power for charging the vehicle 30. For example, two to five first charging contact elements 55 may be arranged in the contact housing 40 in order to exchange electrical power between the charging contact device 15 and the electrical energy storage device of the vehicle 30, in particular in order to charge the electrical energy storage device by means of the electrical power.

The second charging contact element 60 may, for example, be designed as a data contact, in particular, for example, in an assignment as a proximity pilot or control pilot, in order to exchange control signals via the charging contact device 15 with the charging plug 20.

The first and second charging contact elements 55, 60 each extend along a plugin axis 70, wherein the plugin axis 70 is aligned, for example, parallel to the z-axis. To mount the charging plug 20 on the charging contact device 15, the charging plug 20 can be inserted into the charging contact device 15 along the plugin axis 70 in order to electrically contact the charging contact device 15 with a mating contact element 75 designed to correspond to the charging contact element 55, 60. The respective mating contact element 75 is electrically connected to the charging cable 25.

The contact housing 40 delimits a housing interior 80 and a locking space 85 arranged in FIG. 2 in the y-direction offset from the housing interior 80. On a second end face 89 of the charging contact device 15 opposite the first end face 35, the housing cover 62 closes off the housing interior 80 and the locking space 85. The housing interior 80 is substantially completely delimited by the contact housing 40 and the housing cover 62.

The locking space 85 adjoins the housing interior 80 directly in the y-direction, for example, and is enclosed exclusively by the contact housing 40 and the housing cover 62 in at least the x and z-directions.

The contact housing 40 comprises a first housing opening 90 and a second housing opening 95. The first housing opening 90 is arranged along the plugin axis 70 opposite the first end face 35 and is closed in a fluid-tight manner by the housing cover 62.

The second housing opening 95 is arranged in the x-direction between the first end face 35 and the first housing opening 90 and is designed, for example, as a through-opening in the contact housing 40. The second housing opening 95 opens into the locking space 85 and is, for example, significantly smaller than the first housing opening 90.

The second housing opening 95 is sealed in a fluid-tight manner by the locking cover 61, so that both the locking space 85 and the housing interior 80 are sealed in a fluid-tight manner from the surroundings 100 of the charging contact device 15 by the locking cover 61 and the housing cover 62.

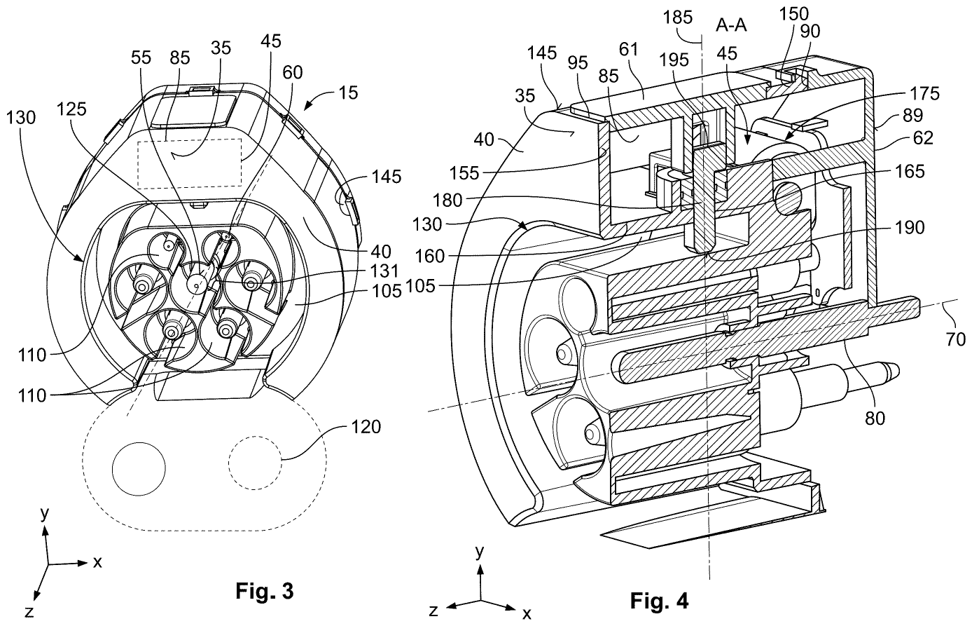

FIG. 3 shows a perspective view of the charging contact device 15 with the view directed towards the first end face 35.

The contact housing 40 comprises a receiving contour 130 on the first end face 35. The receiving contour 130 comprises a receiving space 105 arranged radially outside relative to an outer circumferential side 145 of the contact housing 40 and at least one mating contact receptacle 110. The receiving space 105 is, for example, groove-shaped and is closed at the rear in FIG. 3 on a side facing away from the viewer, in particular in the z-direction, by the contact housing 40 relative to the housing interior 80.

Radially on the inside of the receiving space 105, a plurality of mating contact receptacles 110 are preferably arranged on the first end face 35. In this embodiment, a mating contact receptacle 110 is provided for each of the first and second charging contact elements 55, 60. In the embodiment, for example, the receiving space 105 and the mating contact receptacles 110 are shaped to correspond to the abovementioned IEC Type 2 arrangement. The mating contact receptacles 110 are enclosed by the receiving space 105, which is formed in a substantially annular manner around the mating contact receptacles 110.

In FIG. 3, for example, the charging contact device 15 is designed as an IEC Type 2 charging plug, wherein a DC fast charging connection can be connected in the y-direction on the underside, indicated by the dotted line, so that, for example, the charging contact device 15 can be designed as a CCS charging contact device, in particular as a vehicle-side CCS socket, for example in accordance with IEC 62196 (EN 62196).

The DC charging connection 120 can, for example, be arranged in the y-direction opposite the locking space 85. Of course, it is also possible to dispense with the DC charging connection 120.

The first and second charging contact elements 55, 60 each protrude with a first subsection 131 into the associated mating contact receptacle 110 and each comprise a contact surface 125 on their circumference for contacting the respective associated mating contact element 75 of the charging plug 20.

FIG. 4 shows an enlarged sectional view of the charging contact device 15 shown in FIGS. 1 and 2 along the plane of section A-A shown in FIG. 1.

The contact housing 40 comprises a first housing wall 150, a second housing wall 155 and at least one housing web 160, which are preferably formed in one piece and from the same material. The first housing wall 150 extends circumferentially around the plugin axis 70 and forms the contact housing 40 on the radial outside. The first housing wall 150 encloses the locking space 85 and the housing interior 80 radially towards the outside.

The second housing wall 155 is formed in one piece with and from the same material as the first housing wall 150. The second housing wall 155 is arranged on the first end face 35 and delimits both the locking space 85 and the housing interior 80 in the axial direction relative to the plugin axis 70. In this case, the second housing wall 155 may be designed in a platelike manner in some areas, in particular closest to the locking space 85.

Opposite the housing interior 80, the receiving contour 130 is formed on the second housing wall 155, and the second housing wall 155 separates the receiving space 105, at least in sections, from the housing interior 80 and, if necessary, from the locking space 85.

The housing web 160 is arranged between the receiving space 105 and the locking space 85. The housing web 160 may, for example, be plate-shaped and extend substantially in an xz plane.

In this embodiment, the second housing opening 95 is designed as a through-opening and is formed in the first housing wall 150. The second housing opening 95 can be formed in the first housing wall 150 at a distance from the first housing opening 90 in the z-direction.

The locking space 85 may, for example, be formed in a partially annular shape and adjoins the housing web 160 radially on the outside.

A pin opening 165 is arranged in the housing web 160. The pin opening 165 has a predefined distance in the z-direction from the first end face 35. The predefined distance may result in particular from the standardization for the IEC Type 2 design. Furthermore, the pin opening 165 is formed with a defined profile. The pin opening 165 connects the locking space 85 to the receiving space 105. The pin opening 165 can be formed as a through-opening in the housing web 160.

The locking unit 45 is arranged in the locking space 85. The locking unit 45 comprises a locking drive 175 and a locking pin 180 mechanically connected to the locking drive 175.

The locking pin 180 extends along a locking axis 185, which may be aligned parallel to the y-axis. The locking axis 185 is arranged at an inclination, preferably perpendicularly, with respect to the plugin axis 70. The locking pin 180 comprises a first pin end 190 and a second pin end 195 arranged along the locking axis 185 opposite the first pin end 190.

The locking pin 180 comprises a substantially constant cross-section from the first pin end 190 to the second pin end 195. The locking pin 180 is mechanically connected to the locking drive 175, wherein the locking pin 180 can be moved in a straight line along the locking axis 185 between an unlocking position and a locking position shown in FIG. 4 by means of the locking drive 175.

The locking pin 180 passes through the pin opening 165 in the locking position and protrudes with the first pin end 190 into the receiving space 105. In the locking position, the second pin end 195 is located in the locking space 85 of the contact housing 40.

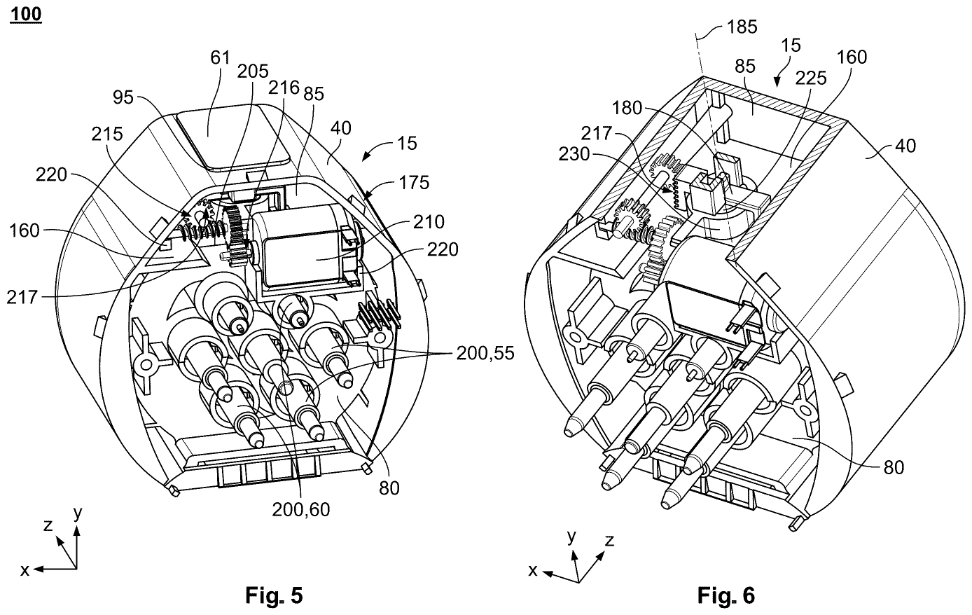

FIG. 5 shows a perspective view of the charging contact device 15, wherein the housing cover 62 is not shown for improved representation of the charging contact device 15.

It can be clearly seen in FIG. 5 that the contact housing 40, which is made in one piece from a single material, for example a nonconductive material, in particular a plastic, completely encloses both the locking space 85 and the housing interior 80, at least at the circumference.

The first and second charging contact elements 55, 60 each protrude into the housing interior 80 with a second subsection 200. The first and second charging contact elements 55, 60 pass through the contact housing 40 at the mating contact receptacle 110. The second subsection 200 is sealed and protected with respect to the surroundings 100 by the contact housing 40 in a fluid-tight manner.

The locking space 85 can be spatially separated from the housing interior 80 by the housing web 160, at least in sections, wherein, however, a connecting opening 205 may be provided in the contact housing 40 between the locking space 85 and the housing interior 80 and provides a fluid connection between the housing interior 80 and the locking space 85.

The locking drive 175 for example comprises a locking motor 210 and a locking gearing 215. The locking gearing 215 comprises a gearing input side 216 and a gearing output side 217. The locking gearing 215 is designed as a reduction gearing. Preferably, the locking gearing 215 is designed to be self-locking so that the locking gearing 215 can only be driven via the gearing input side 216 and not via the gearing output side 217.

The gearing input side 216 of the locking gearing 215 is connected to the locking motor 210 in a torque-locking manner. The gearing output side 217 of the locking gearing 215 is connected to the locking pin 180.

The contact housing 40 comprises a drive carrier 220 arranged in the locking space 85, wherein the drive carrier 220 can, for example, be formed in one piece with and from the same material as the first housing wall 150 and/or the housing web 160. The drive carrier 220 carries individual components of the locking drive 175, for example the locking motor 210 and/or the locking gearing 215.

FIG. 5 shows that the housing cover 62 at the second housing opening 95 seals the locking space 85 with respect to the surroundings 100 in a fluid-tight manner. This prevents liquids or gases from the surroundings 100, in particular from the outside of the vehicle, from entering the locking space 85 via the first housing opening 90 and the housing interior 80 via the connecting opening 205.

FIG. 6 shows a perspective view of the charging contact device 15.

In FIG. 6, similarly to FIG. 5, the illustration of the housing cover 62 has been omitted. In addition, part of the contact housing 40 in the region of the second housing opening 95 is not shown in order to allow the viewer to see into the locking space 85 and the housing interior 80.

The contact housing 40 also comprises a seal carrier 230 on the housing web 160, which is substantially designed as a hollow body and is arranged at a distance from the pin opening 165 (covered by the locking pin 180 in FIG. 6) in the radial direction relative to the locking axis 185.

On the radially inner side, the seal carrier 230 is adjoined by a first sealing element 225, which rests radially on the outer side of the seal carrier 230. On the radially inner side, the first sealing element 225 is penetrated by the locking pin 180, wherein the first sealing element 225 seals the locking space 85 with respect to the receiving space 105 in a fluid-tight manner. Furthermore, the first sealing element 225 also ensures this fluid-tight seal during the movement of the locking pin 180 along the locking axis 185.

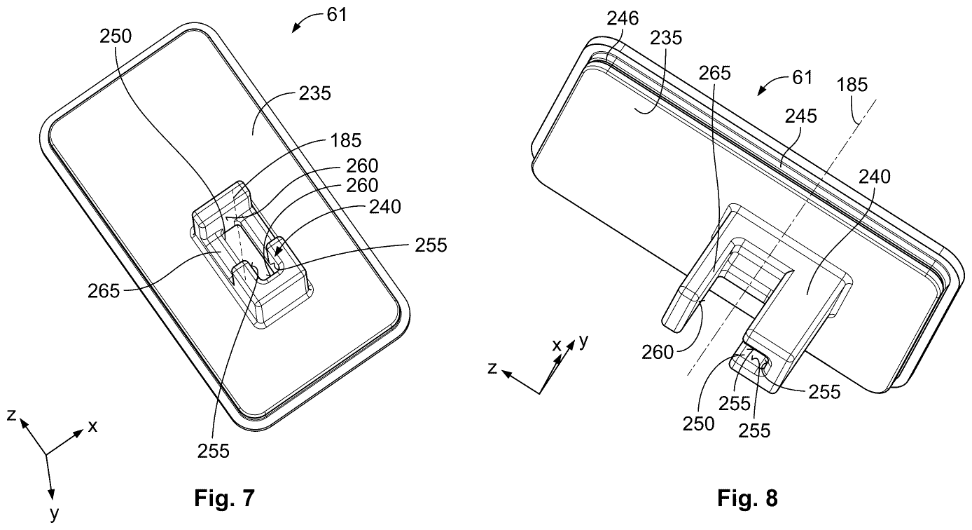

FIG. 7 shows a perspective illustration of the locking cover 61.

The locking cover 61 comprises a cover section 235 and a pin guide 240. The cover section 235 can, for example, be plate-shaped and comprises a cover contour 245 that corresponds to the second housing opening 95. A second sealing element 246 may additionally be arranged on the cover contour 245, for example, which surrounds the cover section 235 on the circumference and is designed to seal the locking space 85 fluidically from the surroundings 100 of the charging contact device 15 at the second housing opening 95.

The pin guide 240 is arranged on the cover section 235 on the side of the cover section 235 facing the locking space 85. The pin guide 240 extends away from the cover section 235 along the locking axis 185 from the cover section 235 into the locking space 85. The pin guide 240 may comprise a plate-shaped basic form on the outside, with a guide receptacle 250 arranged in the pin guide 240.

The guide receptacle 250 comprises, for example, two pairs of guide surfaces, wherein a first pair of guide surfaces comprises two first guide surfaces 255 that are offset from each other in the x-direction and aligned parallel to each other along and parallel to the locking axis 185. The first guide surfaces 255 are arranged, for example, on the inside of the pin guide 240 and form a kind of groove in the pin guide 240.

In addition, the pin guide 240 may comprise a second pair of guide surfaces with two second guide surfaces 260 arranged opposite each other, wherein the second guide surfaces 260 are inclined relative to the first guide surface 255. For example, the second guide surface 260 may extend in an xy plane and parallel to the locking axis 185, while the first guide surface 255 may, by contrast, extend in an xz plane.

The second guide surfaces 260 of the second pair of guide surfaces are also offset, for example arranged in the z-direction relative to each other and parallel to the plugin axis 70.

FIG. 8 shows a further perspective view of the locking cover 61 shown in FIG. 7.

The pin guide 240 may comprise a recess 265 on the side. The recess 265 may be arranged on both sides of the pin guide 240.

The pin guide 240 is open on a side that faces away from the cover section 235. Furthermore, FIG. 8 shows the opposite arrangement of the first and second guide surface pairs, each with the first guide surfaces 255, which are arranged opposite each other in the x-direction, and the second guide surfaces 260 of the second guide surface pair, wherein the second guide surfaces 260 are arranged opposite each other in the z-direction.

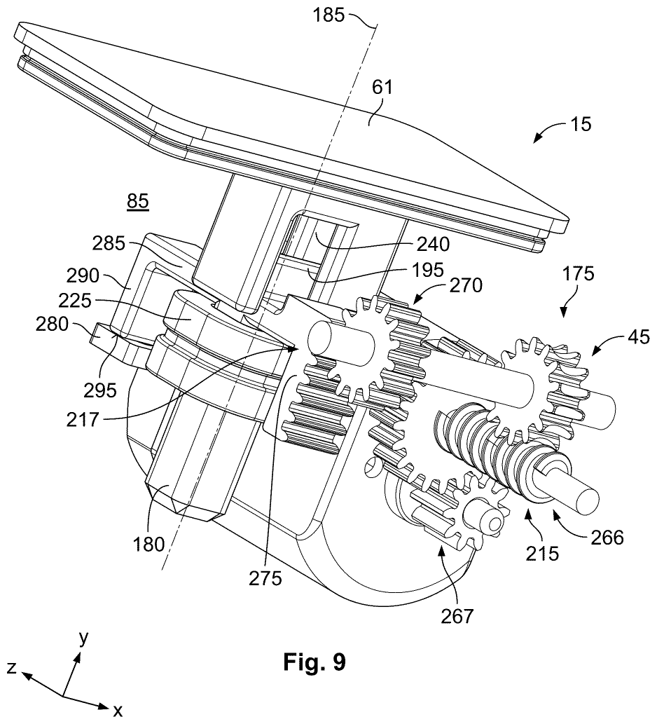

FIG. 9 shows a perspective view of the charging contact device 15 shown in FIGS. 1 to 8 with the locking cover 61 and the locking unit 45.

For reasons of clarity, the other components of the charging contact device 15 are not shown in FIG. 9 in order to better explain the functioning of the locking unit 45.

In this embodiment, the locking gearing 215 is designed with multiple stages and may, for example, comprise a worm gear 266 and/or a spur gear 267 and/or a rack gear 270.

The spur gear 267 is connected, for example, to the gearing input side 216 and is upstream of the worm gear 266. Preferably, a rack gear 270 is connected directly upstream of the gearing output side 217, wherein the rack gear 270 is connected downstream of the worm gear 266.

The rack gear 270 comprises a rack 275 and a gear wheel 270 which is connected to the worm gear 266 for conjoint rotation.

The gear wheel 270 meshes with the rack 275 to ensure movement of the locking pin 180 in a straight line between the locking position and the unlocking position.

Furthermore, the locking drive 175 comprises a limit switch 280, wherein the limit switch 280 is arranged, for example, in the locking space 85 and is fastened, for example, on the underside to the housing web 160 not shown in FIG. 9.

When the charging contact device 15 is in the assembled state, the second pin end 195 of the locking pin 180 engages with the pin guide 240 in both the locking position and the unlocking position, wherein, during the movement of the locking pin 180 along the locking axis 185 between the locking position and the unlocking position, the pin guide 240 guides the locking pin 180, in particular the second pin end 195.

The locking pin 180 is additionally guided in the x and z-directions at a distance from the pin guide 240 via the first sealing element 225 supported on the outside of the seal carrier 230, ensuring reliable movement of the locking pin 180 in a straight line along the locking axis 185 between the locking position and the unlocking position.

The locking pin 180 is further connected to a connecting arm 285. The connecting arm 285 is, for example, inclined relative to the locking pin 180, in particular perpendicular to the locking pin 180, and extends substantially in the x-direction away from the locking pin 180 on both sides. The connecting arm 285 may, for example, be designed in the form of a beam, with the rack 275 connected to the connecting arm 285 at one end. The rack 275 may be aligned parallel to the locking pin 180 and to the locking axis 185.

Opposite the rack 275, a stop bar 290 may be attached to the connecting arm 285 in the x-direction, with the stop bar 290 being connected to the connecting arm 285 on one side in the y-direction. The stop bar 290 and the rack 275 may, for example, extend away from the connecting arm 285 in the same direction in the y-direction. At a free end, the stop bar 290 comprises a stop surface 295 with which the stop bar 290 actuates the limit switch 280 in the locking position.

In a preferred embodiment, the stop bar 290, the connecting arm 285, the locking pin 180 and the rack 275 are manufactured in one piece and from the same material, for example a plastic.

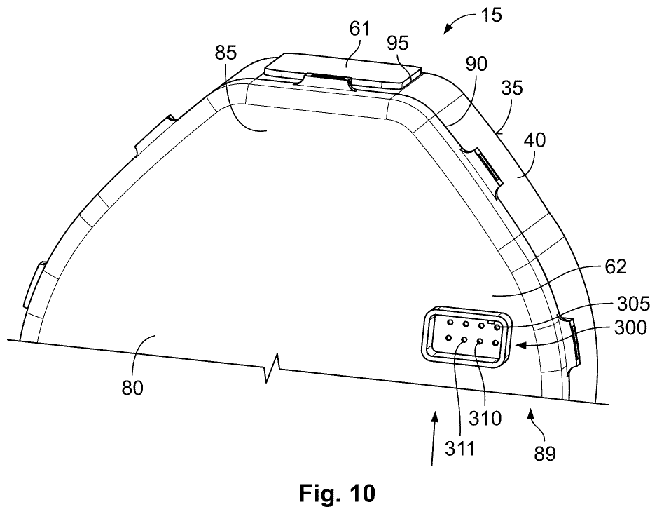

FIG. 10 shows a detail of a perspective view of the charging contact device 15 shown in FIGS. 1 to 9, viewed from the interior of a vehicle towards the charging contact device 15.

The housing cover 62 is arranged on the first housing opening 90 of the contact housing 40 and closes both the locking space 85 and the housing interior 80 on the second end face 89 opposite the first end face 35.

The housing cover 62 can, for example, be connected to the contact housing 40 in a formfitting manner by means of a locking mechanism. Furthermore, the housing cover 62 comprises, for example, a control contact device 300 on the second end face 89.

The control contact device 300 may comprise a first control contact 305, for example a second control contact 310 and preferably at least a third control contact 311, wherein the control contacts 305, 310, 311 are electrically isolated from one another.

The first control contact 305 may, for example, be electrically connected to the locking motor 210, wherein the first control contact 305 supplies, for example, the locking motor 210 with electrical energy and/or a data signal in order to drive and/or control the locking motor 210.

The second control contact 310 may, for example, be electrically connected to the second charging contact element 60 and/or to the limit switch 280.

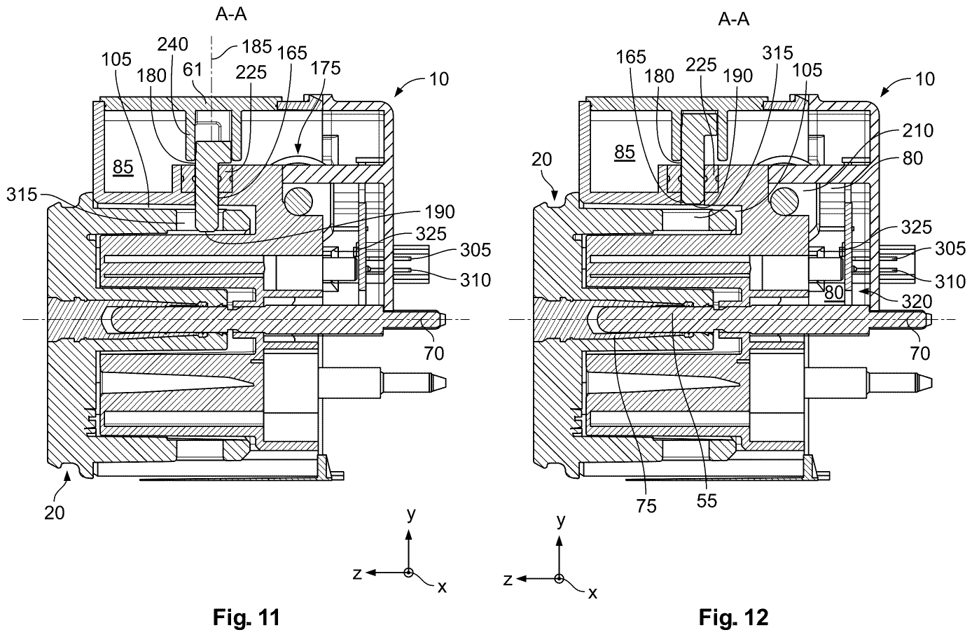

FIG. 11 shows a sectional view along the plane of section A-A, shown in FIG. 1, through the charging system 10 in the locking position.

The third control contact 311 may, for example, be electrically connected to a sensor, such as a temperature sensor 325, or to the limit switch 280.

The temperature sensor 325 is thermally connected to the charging contact arrangement 50 and provides, for example, a temperature signal that correlates, for example, with a temperature of the first charging contact element 55. The temperature signal is transmitted to the second control contact 310 so that the control contact device 300 can be used to operate and control the locking unit 45 and, at the same time, provide a data signal via the operation of the charging contact device 15.

The limit switch 280 provides information about the locking pin 180 reaching the locking position. This information can be used to control the locking drive 175, and, in particular, the locking drive 175 can be deactivated when the locking position is reached.

This design has the advantage that, when installing the charging contact device 15, the charging contact device 15 can be connected to the control contact device 300 in terms of data technology and low-voltage technology in a simple installation step and, in particular, a second contact device can be dispensed with in order to integrate the charging contact device 15 into a low-voltage network and/or into a data network of the vehicle 30.

In FIG. 11, the locking pin 180 is in the locking position. The locking pin 180 passes through not only the pin opening 165 but also the first sealing element 225 and protrudes with the first pin end 190 into the receiving space 105. The locking pin 180 can engage in a pin receptacle 315 of the charging plug 20, which is designed to correspond to the locking pin 180, and thus prevent the charging plug 20 from being unintentionally pulled out of the charging contact device 15, for example during a charging process, by the pin receptacle 315 striking the locking pin 180 on its circumference. It is advantageous if the locking pin 180 preferably passes substantially completely through the receiving space 105, wherein, for example, the first pin end 190 is arranged close to the contact housing 40 arranged opposite the pin opening 165 or strikes there.

To unlock the charging plug 20 and pull the charging plug 20 along the z-axis from the charging contact device 15, the locking pin 180 is moved in a straight line by the locking drive 175 from the locking position along the locking axis 185, which in the embodiment is aligned, for example, perpendicular to the plugin axis 70. As already explained above, the locking pin 180 is guided through the pin guide 240 of the locking cover 61 and retracted into the locking space 85 to such an extent that the first pin end 190 is at least pulled out of the pin receptacle 315.

FIG. 12 shows a sectional view along the sectional plane A-A shown in FIG. 1 through the charging system 10, wherein the charging system 10 is unlocked.

In the unlocked state, the locking pin 180 is in the unlocking position. The locking pin 180 is pulled out of the pin receptacle 315 of the charging plug 20. In this embodiment, the first pin end 190 is preferably arranged in the pin opening 165. The first sealing element 225 seals the locking space 85 with respect to the receiving space 105 both in the locked state (in the locking position of the locking pin 180 shown in FIG. 11) and in the unlocking position of the locking pin 180 shown in FIG. 12. Due to the direct connection of the locking space 85 to the housing interior 80, the first sealing element 225 also indirectly seals the housing interior 80 with respect to the receiving space 105.

In the unlocking position of the locking pin 180 shown in FIG. 12, the charging plug 20 can be plugged in, for example, and an electrical contact can be formed between the mating contact element 75 and the first charging contact element 55. Similarly, a further mating contact element (not shown) can make electrical contact with the second charging contact element 60. Furthermore, in the unlocked state, for example after completion of a charging process, the charging plug 20 can be disconnected from the charging contact device 15.

The charging contact device 15 may comprise a control board 320, wherein the control board 320 comprises, for example, the temperature sensor 325. Furthermore, the first control contact 305 and/or the second control contact 310 and/or the third control contact 311 can be directly attached to the control board 320, which is aligned perpendicular to the plugin axis 70, for example.

The control board 320 may also comprise further semiconductor components which serve, for example, to monitor and/or control the operating state of the charging contact device 15. Furthermore, the locking motor 210 is electrically connected to the control board 320, wherein, for example, at least sections of the control board 320 protrude from the housing interior 80 into the locking space 85. Thus, the control board 320 can not only electrically connect the temperature sensor 325 to the second control contact 310, but also electrically connect the locking motor 210 to the first control contact 305 and simultaneously monitor the operating state of the charging contact device 15.

Because the control board 320 is located both in the interior 80 of the housing and in the locking space 85 and is supported mechanically, for example, by the housing cover 62, it is possible to dispense with additional components for the electrical connection of the locking motor 210, in particular an additional control board and/or additional control contact devices, so that the charging contact device 15 is particularly simple and inexpensive to construct.

The charging contact device 15 shown in FIGS. 1 to 12, in particular the charging system 10, has the advantage that, due to the integrated arrangement of the locking unit 45 in the contact housing 40 of the charging contact device 15, the charging contact device 15 is designed to be particularly compact, especially in the y-direction. Furthermore, a flange for connecting the locking unit, as in conventional charging contact devices, is not required, so that an additional entry point or a difficulty in sealing the locking unit is avoided compared to conventional charging contact devices. This makes the charging contact device 15 shown in the figures particularly reliable and, in particular, ensures that no moisture or dirt enters the locking space 85 or the housing interior 80, not even in adverse weather conditions.

Furthermore, the integration of the locking unit 45 into the contact housing 40 enables the locking unit 45 and the monitoring of the charging contact device 15 to be integrated, for example on the control board 320. Furthermore, only one control contact device 300 is required for this, so that a cable harness to be connected to the charging contact device 15 is particularly simple in design. For this purpose, only a mating control contact device is required to contact the control contact device 300.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Charging contact device for a vehicle, the charging contact device comprising:
a contact housing, a locking unit and a charging contact arrangement,
wherein the charging contact arrangement comprises at least one first charging contact element designed to transmit an electrical charging current,
wherein the first charging contact element comprises a first sub-section extending along a plug-in axis for electrically contacting a mating contact element of a charging plug and a second sub-section arranged offset from the first sub-section,
wherein the contact housing comprises a receiving contour with at least one receiving space on a first end face and a mating contact receptacle offset relative to the receiving space,
wherein the contact housing delimits a locking space and a housing interior away from the first end face relative to the plug-in axis,
wherein the second sub-section of the first charging contact element is arranged in the housing interior and the first charging contact element passes through the contact housing and protrudes into the housing interior with the second sub-section,
wherein the contact housing comprises a pin opening extending between the receiving space and the locking space,
wherein the locking unit is arranged in the locking space of the contact housing.

2. Charging contact device according to claim 1,
wherein the locking unit comprises a locking drive and a locking pin mechanically driven by the locking drive,
wherein the locking drive is designed to move the locking pin between an unlocking position and a locking position offset from the unlocking position,
wherein, in the unlocking position, a first pin end of the locking pin engages with the pin opening and, in the locking position, the locking pin passes through the pin opening and protrudes into the receiving space with the first pin end,
wherein a second pin end arranged opposite the first pin end is arranged in the locking space of the contact housing both in the unlocking position and in the locking position.

3. Charging contact device according to claim 1,
wherein the contact housing comprises a drive carrier arranged in the locking space and/or housing interior,
wherein the locking unit is attached to the drive carrier,
wherein the drive carrier is formed in one piece with and from the same material as the contact housing.

4. Charging contact device according to claim 1,
wherein the contact housing comprises a first housing wall, a second housing wall and a housing web,
wherein the first housing wall extends circumferentially around the plug-in axis and delimits the locking space and the housing interior in the radial direction relative to the plug-in axis,
wherein the second housing wall adjoins the first housing wall at the end face and axially delimits the housing interior and the locking space,
wherein the second housing wall separates the locking space from the receiving space,
wherein the housing web is arranged on the first housing wall and the second housing wall and separates the locking space from the housing interior at least in sections.

5. Charging contact device according to claim 4,
comprising a first sealing element,
wherein the contact housing comprises a seal carrier at the pin opening, which seal carrier is arranged in the locking space,
wherein the seal carrier surrounds the first sealing element circumferentially and secures the first sealing element to the pin opening,
wherein the locking pin passes through the first sealing element and the first sealing element seals the locking space with respect to the receiving space in a fluid-tight manner.

6. Charging contact device according to claim 1,
having a locking cover,
wherein the contact housing comprises a second housing opening,
wherein the second housing opening opens into the locking space,
wherein the locking cover is arranged at the second housing opening and closes the locking space.

7. Charging contact device according to claim 6,
wherein the second housing opening is arranged opposite the pin opening.

8. Charging contact device according to claim 6,
wherein the locking cover comprises a cover section and a pin guide,
wherein the pin guide is arranged on the inside of the cover section and extends from the cover section in the direction of the pin opening,
wherein the locking pin engages in the pin guide on a side facing away from the pin opening, and the pin guide guides the locking pin in a movement between the unlocking position and the locking position,
wherein the cover section is arranged at the second housing opening and closes the second housing opening at the locking space.

9. Charging contact device according to claim 8,
wherein the locking drive comprises a locking motor and a locking gearing,
wherein the locking motor is connected on the output side to a gearing input side of the locking gearing,
wherein the locking gearing comprises at least one rack gearing with a rack,
wherein the rack is connected to the locking pin to move the locking pin in a straight line along a locking axis between the locking position and the unlocking position.

10. Charging contact device according to claim 1,
having a housing cover,
wherein the housing cover is attached to the contact housing on a side of the contact housing opposite the receiving space and closes off the housing interior and the locking space.

11. Charging contact device according to claim 1,
having a control contact device,
wherein the control contact device is arranged on a side facing away from the receiving space,
wherein the control contact device comprises at least one first control contact and a second control contact arranged offset from the first control contact,
wherein the locking unit can be controlled via the first control contact,
wherein information about an operating state of the charging contact arrangement, in particular a temperature and/or a charging state, can be provided via the second control contact,
wherein the control contact device is arranged on the housing cover on a side facing away from the charging contact arrangement.

12. Charging contact device according to claim 11,
wherein the locking drive comprises a locking motor and a locking gearing,
wherein the locking gearing comprises a gearing input side and a gearing output side,
wherein the gearing input side of the locking gearing is connected to the locking motor in a torque-locking manner,
wherein the gearing output side of the locking gearing is connected to the locking pin,
wherein the locking gearing is preferably designed as a reduction gearing,
wherein the locking gearing is designed to be self-locking, so that the locking gearing can only be driven via the gearing input side.

13. Method for operating a charging contact device comprising:
providing a charging contact device including a contact housing, a locking unit and a charging contact arrangement, wherein the charging contact arrangement comprises at least one first charging contact element designed to transmit an electrical charging current, wherein the first charging contact element comprises a first sub-section extending along a plug-in axis for electrically contacting a mating contact element of a charging plug and a second sub-section arranged offset from the first sub-section, wherein the contact housing comprises a receiving contour with at least one receiving space on a first end face and a mating contact receptacle offset relative to the receiving space, wherein the contact housing delimits a locking space and a housing interior away from the first end face relative to the plug-in axis, wherein the second sub-section of the first charging contact element is arranged in the housing interior and the first charging contact element passes through the contact housing and protrudes into the housing interior with the second sub-section, wherein the contact housing comprises a pin opening extending between the receiving space and the locking space, wherein the locking unit is arranged in the locking space of the contact housing;
engaging the locking pin with a first pin end in the pin opening in the unlocking position; and
passing the first pin end through the pin opening in the locking position with the first pin end protruding into the receiving space,
wherein the locking unit moves the locking pin between the unlocking position and the locking position.

14. Method according to claim 13,
wherein the locking pin is moved in a straight line between the locking position and the unlocking position.
